(19) United States
(12) Patent Application Publication
(10) Pub. No.: US 2023/0142642 A1
(43) Pub. Date: May 11, 2023

(54) VEHICLE CONTROL SYSTEM, APPARATUS, AND METHOD

(71) Applicant: NEC Corporation, Minato-ku, Tokyo (JP)

(72) Inventors: Takashi YAMANE, Tokyo (JP); Masayuki Sakata, Tokyo (JP); Takanori Iwai, Tokyo (JP); Koichi Nihei, Tokyo (JP); Kosei Kobayashi, Tokyo (JP); Yusuke Shinohara, Tokyo (JP)

(73) Assignee: NEC Corporation, Minato-ku, Tokyo (JP)

(21) Appl. No.: 17/912,124

(22) PCT Filed: Mar. 31, 2020
(86) PCT No.: PCT/JP2020/014770

§ 371 Date: Sep. 16, 2022

(51) Int. Cl. G05D 1/00; G08G 1/01; G05D 1/02

(52) U.S. Cl. CPC G05D 1/0027; G05D 1/0297; G08G 1/0133

(57) ABSTRACT

A vehicle configured to so as to be able to be remotely driven transmits information about each vehicle to a vehicle control apparatus through a network. In the vehicle control apparatus, an analysis unit receives information about each vehicle. The analysis unit analyzes state information of each vehicle based on the received information about each vehicle. Each remote control unit performs at least one of remote monitoring or remote control for at least one of a plurality of vehicles. An assignment determination unit determines a correspondence relationship between the vehicle and the remote control unit based on the analyzed state information.

### TECHNICAL FIELD

The present disclosure relates to a vehicle control system, an apparatus, a method, and a computer readable medium.

### BACKGROUND ART

In recent years, technologies for autonomous vehicles have been attracting attention. Autonomous driving is classified into a plurality of levels, i.e., into five levels from a level 1 at which a vehicle assists the driver in driving the vehicle to a level 5 at which the vehicle travels in a completely autonomous manner. When a vehicle travels in a completely autonomous manner, no driver needs to be in the vehicle. However, if autonomous driving becomes impossible in the state where no driver is in the vehicle, the vehicle may remain at a standstill and be unable to move. It is thus considered that when, in particular, an autonomous vehicle is made to travel without any driver, remote monitoring of the vehicle is important.

As a related art, Patent Literature 1 discloses an apparatus for remote monitoring and remote control of an autonomously traveling vehicle. In Patent Literature 1, each vehicle capable of autonomous traveling is assigned to a vehicle manager. The vehicle manager is used for remote monitoring and remote control of the vehicle. The vehicle is automatically assigned to a vehicle manager assignment queue by using, for example, a machine learning technology. Patent Literature 1 discloses that a load distribution is performed among vehicle managers.

In Patent Literature 1, a system receives status data from a plurality of vehicles. The vehicle manager determines whether or not the status data of a vehicle indicates that the vehicle is autonomously operating in a state in which a parameter is outside a defined parameter value range. When it is determined that the status data of the vehicle indicates that the vehicle is autonomously operating in the state in which the parameter is outside the defined parameter value range, the vehicle manager transmits specific instruction data to the vehicle.

As another related art, Patent Literature 2 discloses a system for remotely monitoring a mobile object such as an autonomous bus. In Patent Literature 2, a plurality of observers remotely monitor a plurality of autonomous buses. In Patent Literature 2, for example, one observer A remotely monitors three autonomous buses, and another supervisor B remotely monitors two autonomous buses.

When a predetermined event indicating a possibility of a failure has occurred in a bus, an observer transmits information indicating that the predetermined event has occurred to a determination apparatus by using a terminal apparatus. The determination apparatus determines that the bus satisfies a predetermined condition(s) based on the information indicating that the predetermined event has occurred in the bus, acquired from the terminal apparatus. The determination apparatus determines a monitoring mode for the plurality of buses when the bus satisfies the predetermined condition(s). For example, when the predetermined event has occurred in one of the buses monitored by the observer A, the determination apparatus changes the observer who monitors the remaining two buses, which has been monitored by the observer A, to the observer B.

### Citation List

### Patent Literature

Patent Literature 1: Published Japanese Translation of PCT International Publication for Patent Application, No. 2019-537155
Patent Literature 2: Japanese Unexamined Patent Application Publication No. 2018-206222

### SUMMARY OF INVENTION

### Technical Problem

Patent Literature 1 discloses that a remote support apparatus receives status data from a vehicle and assigns the vehicle to a remote driving support queue based on the received status data. The remote support apparatus receives the status data of the vehicle including an instruction about the destination of the vehicle. The remote support apparatus assigns a plurality of vehicles having the same destination to the same remote driving support queue (to the same vehicle manager). In Patent Literature 1, the assignment between a vehicle and a vehicle manager is determined according to the status data received from the vehicle. Therefore, there is a possibility that the remote support apparatus cannot accurately recognize the situation of the vehicle and hence cannot assign the vehicle to an appropriate vehicle manager.

In Patent Literature 2, the determination apparatus acquires, from a bus to be monitored, information such as sounds in the bus and moving images of the bus. The determination apparatus determines whether or not the situation of the bus to be monitored satisfies a predetermined condition(s) based on the acquired information. The determination apparatus determines that the predetermined condition is satisfied when an event that prevents the movement of the bus has occurred, when a failure occurs in the bus, or when a trouble or the like has occurred ahead of the bus. However, in Patent Literature 2, the predetermined condition is used as a trigger for changing the correspondence relationship between the observer and the bus. In Patent Literature 2, there is also a possibility that the situation of the vehicle cannot be accurately recognized and hence the bus that needs to be remotely controlled cannot be assigned to an appropriate observer.

In view of the above-described circumstances, an object of the present disclosure is to provide a vehicle control system, an apparatus, a method, and a computer readable medium capable of assigning mobile objects to be monitored to observers according to the situations of the mobile objects.

### Solution to Problem

In order to achieve the above-described object, the present disclosure provides a vehicle control system including: a plurality of vehicles, each of the plurality of vehicles being configured so as to be able to be remotely driven; an analysis means for receiving information about each of the plurality of vehicles from each of the vehicles through a network, and analyzing state information of each of the vehicles based on the received information about each of the vehicles; a plurality of remote control means, each of the plurality of remote control means being capable of performing at least one of remote monitoring or remote control for at least one of the plurality of vehicles; and an assignment determination means for determining a correspondence relationship between the vehicles and the remote control means based on the state information analyzed by the analysis means.

The present disclosure provides a vehicle control apparatus including: an analysis means for receiving information about each of a plurality of vehicles from each of the vehicles through a network, and analyzing state information of each of the vehicles based on the received information about each of the vehicles, each of the vehicles being configured so as to be able to be remotely driven; a plurality of remote control means, each of the plurality of remote control means being capable of performing at least one of remote monitoring or remote control for at least one of the plurality of vehicles; and an assignment determination means for determining a correspondence relationship between the vehicles and the remote control means based on the state information analyzed by the analysis means.

The present disclosure provides a vehicle control method including: receiving information about each of a plurality of vehicles from each of the vehicles through a network, and analyzing state information of each of the vehicles based on the received information about each of the vehicles, each of the vehicles being configured so as to be able to be remotely driven; and determining a correspondence relationship between a plurality of remote control apparatuses and the vehicles based on the analyzed state information, each of the plurality of remote control apparatuses being capable of performing at least one of remote monitoring or remote control for at least one of the plurality of vehicles.

The present disclosure provides a non-transitory computer readable medium storing a program for causing a computer to perform processes including: receiving information about each of a plurality of vehicles from each of the vehicles through a network, and analyzing state information of each of the vehicles based on the received information about each of the vehicles, each of the vehicles being configured so as to be able to be remotely driven; and determining a correspondence relationship between a plurality of remote control apparatuses and the vehicles based on the analyzed state information, each of the plurality of remote control apparatuses being capable of performing at least one of remote monitoring or remote control for at least one of the plurality of vehicles.

### ADVANTAGEOUS EFFECTS OF INVENTION

A vehicle control system, an apparatus, a method, and a computer readable medium according to the present disclosure can assign mobile objects to be monitored to observers according to the situations of the mobile objects.

### BRIEF DESCRIPTION OF DRAWINGS

FIG. 1 is a block diagram schematically showing a vehicle control system according to the present disclosure;

FIG. 2 is a block diagram for showing a vehicle control system according to an example embodiment of the present disclosure;

FIG. 3 is a block diagram showing an example of a configuration of a vehicle control apparatus 101;

FIG. 4 shows an example of observer information;

FIG. 5 is a flowchart showing an operation procedure performed in a vehicle control system; and

FIG. 6 is a block diagram showing an example of a configuration of a computer apparatus.

### EXAMPLE EMBODIMENT

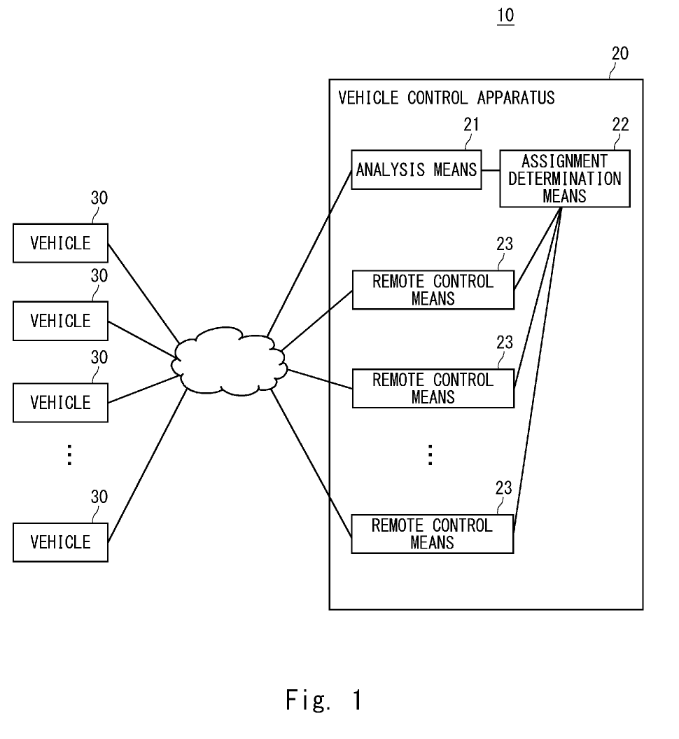

Prior to describing an example embodiment according to the present disclosure, an outline of the present disclosure will be described. FIG. 1 schematically shows a vehicle control system according to the present disclosure. The vehicle control system 10 includes a vehicle control apparatus 20 and a plurality of vehicles 30. The vehicle control apparatus 20 includes an analysis means 21, an assignment determination means 22, and a plurality of remote control means 23. In the vehicle control system 10, the vehicle control apparatus 20 and each of the vehicles 30 communicate with each other through a network.

Each vehicle 30 is configured so as to be able to be remotely driven. Each vehicle 30 transmits information about the vehicle itself to the vehicle control apparatus 20 through the network. In the vehicle control apparatus 20, the analysis means 21 receives the information about each of the vehicles. The analysis means 21 analyzes state information of each of the vehicles based on the received information about each of the vehicles.

Each of the remote control means 23 performs at least one of remote monitoring or remote control for at least one of the plurality of vehicles 30. The assignment determination means 22 determines a correspondence relationship between the vehicles 30 and the remote control means 23 based on the state information analyzed by the analysis means 21. The remote control means 23 performs at least one of remote monitoring or remote control for a vehicle(s) assigned thereto.

In the present disclosure, the analysis means 21 analyzes information acquired from the vehicles 30, and analyzes state information of each of the vehicles. The assignment determination means 22 determines, based on the result of the analysis, which of the remote control means 23 each of the vehicles 30 should be assigned to. Each of the remote control means 23 is associated with, for example, an observer who performs remote monitoring and remote control. The vehicle control system 10 assigns each of the vehicles to one of the remote control means 23 based on the result of the analysis of the state information of each of the vehicles. In this manner, the present disclosure makes it possible to assign mobile objects to be monitored to observers according to the situations of the mobile objects.

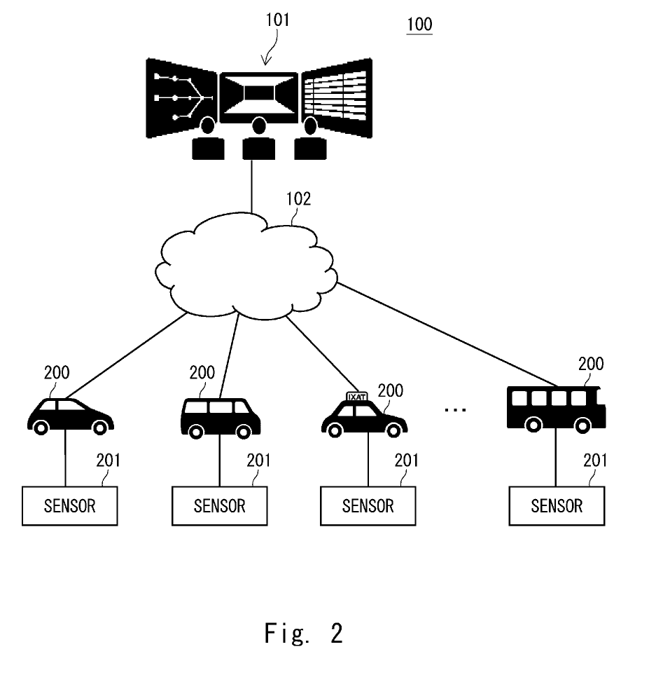

An example embodiment according to the present disclosure will be described hereinafter in detail. FIG. 2 shows a vehicle control system according to an example embodiment of the present disclosure. A vehicle control system 100 includes a vehicle control apparatus 101 and a plurality of vehicles 200. In the vehicle control system 100, the vehicle control apparatus 101 and the plurality of vehicles 200 are connected to each other through a network 102. The network 102 includes, for example, a network in conformity with communication line standards such as LTE (Long Term Evolution), a radio communication network such as WiFi (Registered Trademark), or a fifth generation mobile communication system. The vehicle control system 100 corresponds to the vehicle control system 10 shown in FIG. 1.

Each of the vehicles 200 is constructed as a mobile object such as an automobile, a truck, a bus, a taxi, or a train. The plurality of vehicles 200 include vehicles (passenger vehicles) that carry passengers, such as buses and taxis. Each of the plurality of vehicles 200 has an associated sensor 201. The sensor 201 includes a camera that photographs a surrounding area of the vehicles. Further, the sensor 201 includes a camera that photographs the inside of the vehicle. In this example embodiment, the vehicle 200, in particular, the passenger vehicle 200, includes a camera that photographs the inside of the vehicle. The sensor 201 may include a sensor that detects the traveling speed, the position, and the like of the vehicle 200. The sensor 201 may include, but is not limited to, a range sensor or the like, an environmental sensor or the like, and a vehicle body sensor or the like. The range sensor or the like includes, for example, at least one of a laser radar (LiDAR: Light Detection and Ranging), a millimeter-wave radar, or an ultrasonic sensor. The environmental sensor or the like includes sensors that detect a temperature, a sound, a humidity, and the like. The vehicle body sensor or the like includes sensors that detect a steering angle of a steering wheel, a rpm (revolutions per minute) of an engine, a remaining amount of fuel, and the like.

Each vehicle 200 transmits sensor information acquired by the sensor 201 to the vehicle control apparatus 101 through the network 102. Each vehicle 200 may transmit information different from the sensor information to the vehicle control apparatus 101 through the network 102. Each vehicle 200 is configured so as to be able to be remotely driven. At least one of the plurality of vehicles 200 may be configured so as to be able to perform automatic driving (autonomous driving). When the vehicle 200 is configured so as to be able to perform automatic driving (autonomous driving), the vehicle 200 performs autonomous driving by using the sensor information acquired by the sensor 201. The vehicle 200 corresponds to the vehicle 30 shown in FIG. 1.

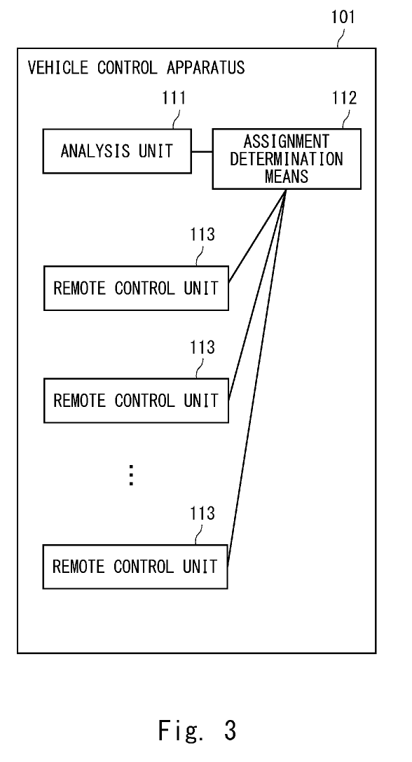

The vehicle control apparatus 101 remotely monitors and remotely controls the plurality of vehicles 200 through the network 102. FIG. 3 shows an example of a configuration of the vehicle control apparatus 101. The vehicle control apparatus 101 includes an analysis unit 111, an assignment determination unit 112, and a plurality of remote control units 113. The vehicle control apparatus 101 corresponds to the vehicle control apparatus 20 shown in FIG. 1.

The analysis unit 111 receives sensor information transmitted from each of the vehicles 200 as information related to each of the vehicles (i.e., information related to that vehicle). The analysis unit 111 may receive other information transmitted from each of the vehicles 200 as information related to the vehicles. The analysis unit 111 analyzes state information of each of the vehicles based on the sensor information thereof. The assignment determination unit 112 determines a correspondence relationship between the vehicles 200 and the remote control units 113 based on the state information of each of the vehicles analyzed by the analysis unit 111. In this example embodiment, the number of remote control units 113 is, for example, equal to or smaller than the number of vehicles 200. One remote control unit 113 may be associated with two or more vehicles 200. Alternatively, one vehicle 201 may be associated with two or more remote control units 113. The analysis unit 111 corresponds to the analysis means 21 shown in FIG. 1. The assignment determination unit 112 corresponds to the assignment determination means 22 shown in FIG. 1.

The remote control unit 113 performs at least one of remote monitoring or remote control for a vehicle(s) 200 that has been associated therewith by the assignment determination unit 112. Each of the remote control units 113 is associated with an observer. In the remote monitoring of a vehicle, the remote control unit 113 displays sensor information transmitted from the vehicle on a monitoring screen. The observer remotely monitors the vehicle 200 by watching or observing sensor information, e.g., an image which is obtained by photographing the surrounding area of the vehicle, displayed on the monitoring screen.

In the remote control of a vehicle, the remote control unit 113 transmits, for example, a command for remotely controlling the vehicle 200 to the vehicle 200. For example, the vehicle 200 receives a command for instructing to perform control, such as to avoid an obstacle, to start a right turn, or to move closer to a road shoulder and stop there, and moves according to the control, i.e., according to the received command. The remote control unit 113 may include a device that imitates, for example, a steering wheel or an accelerator pedal of the vehicle 200. The remote control unit 113 may remotely steer the vehicle 200 by transmitting, to the vehicle 200, information indicating an amount of an operation performed on the device imitating a steering wheel, an accelerator pedal, or the like by the observer. The remote control unit 113 corresponds to the remote control means 23 shown in FIG. 1.

When the vehicle 200 is configured so as to be able to perform autonomous driving, the remote control unit 113 can control the autonomous driving performed by the vehicle 200 by specifying a control policy based on the sensor information received from the vehicle 200 and transmitting the specified the control policy to the vehicle 200. Note that the control policy is information indicating a control policy to be applied to the autonomous driving performed by the vehicle. The control policy has, for example, a hierarchical structure including a plurality of layers, and the highest layer provides an abstract instruction to the vehicle. In the control policy, the lower the layer is, the more specific the instruction to be provided becomes. The control policy includes, for example, information indicating switching from autonomous driving to remote driving, a change in an AI (Artificial Intelligence) application rule in the driving performed on the vehicle side, or a change in the policy (a control algorithm of the autonomous driving) currently applied in the autonomous driving.

The remote control unit 113 determines whether or not the vehicle 200 can continue the autonomous driving based on, for example, the sensor information. When the remote control unit 113 determines that the vehicle 200 cannot continue the autonomous driving, the remote control unit 113 transmits, to the vehicle 200, a control policy indicating switching from the autonomous driving to remote control. In this case, the vehicle 200 hands over the right to control the vehicle to the remote control unit 113 according to the control policy. The sensor information used for specifying the control policy may be the same as the sensor information used for analyzing the state information of the vehicle in the analyzing section 111, or may be partially or entirely different therefrom.

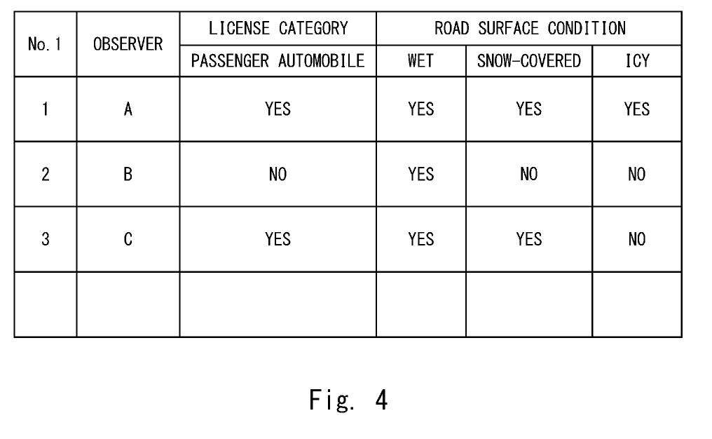

For example, the assignment determination unit 112 holds, for each of the remote control units 113, information about an observer (observer information) associated with that remote control unit 113, and uses this information to determine the correspondence relationship between that remote control unit 113 and the vehicle(s) 200. FIG. 4 shows an example of the observer information. In this example, the observer information includes information indicating categories of licenses and suitability information for road-surface conditions. The information indicating the category of the license indicates whether or not the observer can drive a passenger vehicle. The suitability information indicates whether or not the observer can take charge of the remote driving of the vehicle when the road-surface condition is “wet”, “snow-covered”, or “icy”. The assignment determination unit 112 can determine the correspondence relationship between the remote control unit 113 and the vehicle 200 based on the observer information and the result of the analysis by the analysis unit 111.

For example, the analysis unit 111 receives an image(s) of the inside of the vehicle 200 which is a passenger vehicle such as a bus or a taxi. The analysis unit 111 analyzes whether or not a passenger is in the vehicle 200 based on the received image. The assignment determination unit 112 determines the correspondence relationship between the remote control unit 113 and the vehicle 200 based on the result of the analysis as to whether or not a passenger is in the vehicle and the type of the license indicated in the remote observer information.

When a passenger is in the vehicle 200, which is a passenger vehicle, the assignment determination unit 112 assigns this vehicle 200 to a remote control unit 113 that is associated with a remote observer who possess a license for driving passenger vehicles. When no passenger is in the vehicle 200, which is a passenger vehicle, the assignment determination unit 112 assigns a remote control unit 113 that is associated with an arbitrary observer to this vehicle 200. For example, in the example shown in FIG. 4, observers A and C are capable of driving passenger vehicles. When a passenger is in the vehicle 200, the assignment determination unit 112 assigns this vehicle 200 to a remote control unit 113 associated with the observer A or C. In this case, when it becomes necessary to remotely drive the vehicle 200, it is possible to smoothly shift the state of the vehicle 200 from the remote monitoring to the remote driving. When no passenger is in the vehicle 200, the assignment determination unit 112 assigns the vehicle to a remote control unit 113 associated with any of the observers A to C.

The analysis unit 111 may receive information indicating whether or not the vehicle 200, which is a passenger vehicle, is out of service from the vehicle 200, and analyze whether or not the vehicle is out of service based on the received information. The assignment determination unit 112 may determine the correspondence relationship between the vehicle and the remote control unit 113 based on the result of analysis as to whether or not the vehicle 200 is out of service and the type of the license of the remote observer. For example, when the vehicle is not out of service, the assignment determination unit 112 assigns the vehicle to a remote control unit 113 associated with a remote observer who possesses a license for driving passenger vehicles. In this manner, when it becomes necessary to remotely drive the vehicle 200, it is possible to smoothly shift the state of the vehicle 200 from the remote monitoring to the remote driving. When the vehicle is out of service, the assignment determination unit 112 assigns the vehicle to a remote control unit 113 associated with an arbitrary observer.

The analysis unit 111 may analyze the road-surface condition of the place where the vehicle is traveling based on the sensor information. The analysis unit 111 may analyze, for example, the weather and the road-surface condition by performing an image analysis on an image(s) acquired from the vehicle. The analysis unit 111 may receive information about the weather in the place where the vehicle is traveling from an external server, and analyze the road-surface condition based on the received information about the weather. The analysis unit 111 analyzes, for example, whether the road-surface condition is a dry road surface, a wet road surface, a snow-covered road surface, or an icy road surface.

The assignment determination unit 112 may determine the correspondence relationship between the vehicle 200 and the remote control unit 113 based on the analyzed road-surface condition and the suitability information included in the remote observer information. When the road-surface condition is analyzed or determined as a “dry road surface”, the assignment determination unit 112 assigns the vehicle to a remote control unit 113 associated with an arbitrary observer. When the road-surface condition is analyzed as a “wet road surface”, a “snow-covered road surface”, or an “icy road surface”, the assignment determination unit 112 assigns the vehicle to a remote control unit 113 associated with a remote observer capable of taking charge of the analyzed road-surface condition. For example, when the road-surface condition is analyzed as an “icy road surface”, the assignment determination unit 112 refers to the observer information shown in FIG. 4 and assigns the vehicle traveling on the icy road surface to the remote control unit 113 associated with the observer A. In this case, when it becomes necessary to remotely drive the vehicle 200, it is possible to smoothly shift the state of the vehicle 200 from the remote monitoring to the remote driving.

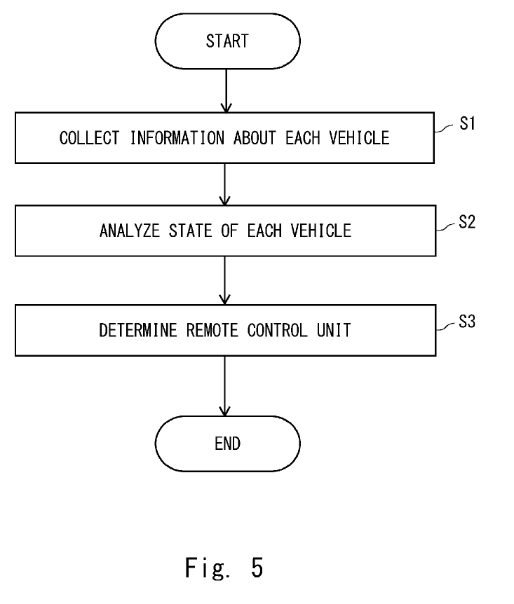

Next, an operation procedure performed in the vehicle control system 100 will be described. FIG. 5 shows an operation procedure (a vehicle control method) performed in the vehicle control system 100. Each of the vehicles 200 transmits sensor information acquired by the sensor 201 to the vehicle control apparatus 101 through the network 102.

In the vehicle control apparatus 101, the analysis unit 111 collects information of each of the vehicles (Step S1). The information collected by the analysis unit 111 in the step S1 includes the sensor information transmitted from each of the vehicles 200. The information collected by the analysis unit 111 may include information other than the sensor information transmitted from each of the vehicles 200. Further, the information collected by the analysis unit 111 may include information transmitted from an external apparatus, such as an external server, other than the vehicle 200.

The analysis unit 111 analyzes state information of each of the vehicles based on the information collected in the step S1 (Step S2). The assignment determination unit 112 determines a remote control unit 113 that will take charge of the remote monitoring and the like of the vehicle 200 based on the result of the analysis of the state information of each of the vehicles (Step S3). Each of the observers who have been associated with respective remote control units 113 performs the remote monitoring or the remote control of the vehicle 200 according to the determination made by the assignment determination unit 112.

In this example embodiment, the analysis unit 111 analyzes the state information of each of the vehicles based on the sensor information of the vehicles. The assignment determination unit 112 determines the correspondence relationship between the vehicle 200 and the remote control unit 113 based on the result of the analysis of the state information. In this manner, the assignment determination unit 112 can assign the vehicle 200 to a remote control unit 113 associated with an appropriate observer according to the situation of the mobile object to be monitored, i.e., the vehicle 200 to be monitored. For example, it is possible to smoothly shift the state of the vehicle 200 from the remote monitoring to the remote driving (the remote control) by assigning beforehand the vehicle 200 to a remote control unit 113 associated with an observer capable of driving that vehicle 200.

Note that the assignment determination unit 112 may determine the correspondence relationship between the vehicle 200 and the remote control unit 113 with consideration given to not only the result of the analysis by the analysis unit 111 but also to other information. For example, the assignment determination unit 112 may hold information about the skill of each observer in advance, and determine the correspondence relationship between the vehicle 200 and the remote control unit 113 by using this information. For example, the assignment determination unit 112 stores, for each observer, the number of times of remote driving the observer performed in the past (and/or the number of occurrences of troubles) for each area where the vehicle 200 travels. The assignment determination unit 112 may determine the correspondence relationship between the vehicle 200 and the remote control unit 113 with consideration given to this information. Alternatively, the assignment determination unit 112 stores, for each observer, the number of times of remote driving the observer performed in the past (and/or the number of occurrences of troubles) for each type of vehicles 200. The assignment determination unit 112 may determine the correspondence relationship between the vehicle 200 and the remote control unit 113 with consideration given to this information.

The assignment determination unit 112 may hold, for each observer, information that is obtained by converting the skill of that observer for the remote driving into a score in advance, and may determine the correspondence relationship between the vehicle 200 and the remote control unit 113 with consideration given to this information. For example, when an important person is in the vehicle 200, the assignment determination unit 112 may preferentially assign a remote control unit 113 associated with an observer having a high score to this vehicle 200. Alternatively, a user may select, when making a contract, a desired course from a plurality of courses having different fees (i.e., different prices), and the assignment determination unit 112 may determine the correspondence relationship between the vehicle 200 and the remote control unit 113 according to the course selected by the user. For example, for a vehicle for which a user has made a contract for a course having the highest fee (i.e., the highest price), the assignment determination unit 112 may assign a remote control unit 113 associated with an observer having a predetermined score or higher to that vehicle. For example, for a vehicle for which a user has made a contract for a course having the lowest fee (i.e., the lowest price), the assignment determination unit 112 may assign a remote control unit 113 associated with an observer having a low score or an inexperienced observer to that vehicle.

The assignment determination unit 112 may schedule, before the vehicle 200 reaches a place where the vehicle 200 cannot travel by performing autonomous driving, the correspondence relationship between the vehicle 200 and the remote control unit 113 by using the traveling plan of the vehicle 200. Further, the assignment determination unit 112 may determine the correspondence relationship between the vehicles 200 and the remote control units 113 so that the workloads for the remote monitoring or the remote control of all the observers are leveled or uniformly distributed. For example, the assignment determination unit 112 calculates, for each of the vehicles, a workload score for the remote monitoring or the remote control based on information related to the number of curves, the degree of congestion, and the like in the place where the vehicle travels. The assignment determination unit 112 may determine the correspondence relationship between the vehicles 200 and the remote control units 113 so that the workload scores of all the observers are leveled or uniformly distributed. Further, the assignment determination unit 112 may determine the correspondence relationship between the vehicles 200 and the remote control units 113 so that the workloads are leveled, i.e., in order to prevent any of the remote observers from carrying out remote monitoring or remote control for a large number of vehicles 200.

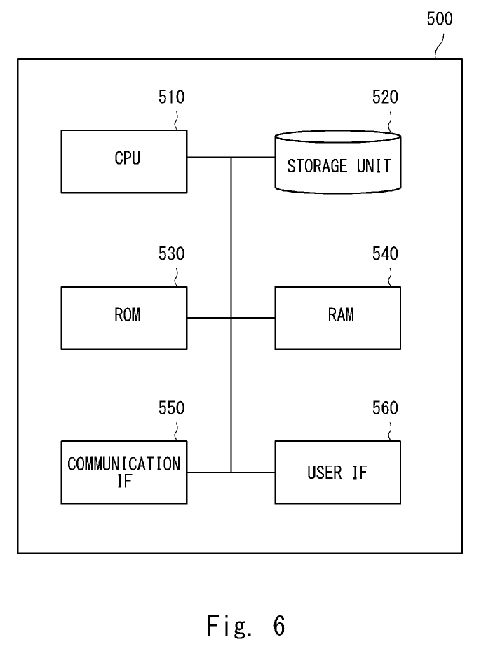

In the present disclosure, the vehicle control apparatus 101 can be configured as a computer apparatus (a server apparatus). FIG. 6 shows an example of a configuration of a computer apparatus that can be used as the vehicle control apparatus 101. The computer apparatus 500 includes a control unit (CPU: Central Processing Unit) 510, a storage unit 520, a ROM (Read Only Memory) 530, a RAM (Random Access Memory) 540, a communication interface (IF: Interface) 550, and a user interface 560.

The communication interface 550 is an interface for connecting the computer apparatus 500 to a communication network through wired communication means, wireless communication means, or the like. The user interface 560 includes, for example, a display unit such as a display. Further, the user interface 560 includes an input unit such as a keyboard, a mouse, and a touch panel.

The storage unit 520 is an auxiliary storage device that can hold various types of data. The storage unit 520 does not necessarily have to be a part of the computer apparatus 500, but may be an external storage device, or a cloud storage connected to the computer apparatus 500 through a network.

The ROM 530 is a non-volatile storage device. For example, a semiconductor storage device such as a flash memory having a relatively small capacity can be used for the ROM 530. A program(s) that is executed by the CPU 510 may be stored in the storage unit 520 or the ROM 530. The storage unit 520 or the ROM 530 stores, for example, various programs for implementing the function of each unit in the vehicle control apparatus 101.

The aforementioned program can be stored and provided to the computer apparatus 500 by using any type of non-transitory computer readable media. Non-transitory computer readable media include any type of tangible storage media. Examples of non-transitory computer readable media include magnetic storage media such as floppy disks, magnetic tapes, and hard disk drives, optical magnetic storage media such as magneto-optical disks, optical disk media such as CD (Compact Disc) and DVD (Digital Versatile Disk), and semiconductor memories such as mask ROM, PROM (Programmable ROM), EPROM (Erasable PROM), flash ROM, and RAM. Further, the program may be provided to a computer using any type of transitory computer readable media. Examples of transitory computer readable media include electric signals, optical signals, and electromagnetic waves. Transitory computer readable media can provide the program to a computer via a wired communication line such as electric wires and optical fibers or a radio communication line.

The RAM 540 is a volatile storage device. As the RAM 540, various types of semiconductor memory apparatuses such as a DRAM (Dynamic Random Access Memory) or an SRAM (Static Random Access Memory) can be used. The RAM 540 can be used as an internal buffer for temporarily storing data and the like. The CPU 510 deploys or loads a program stored in the storage unit 520 or the ROM 530 in the RAM 540, and executes the deployed or loaded program. The function of each unit in the vehicle control apparatus 101 can be implemented by having the CPU 510 execute a program. The CPU 510 may include an internal buffer in which data and the like can be temporarily stored.

Although example embodiments according to the present disclosure have been described above in detail, the present disclosure is not limited to the above-described example embodiments, and the present disclosure also includes those that are obtained by making changes or modifications to the above-described example embodiments without departing from the spirit of the present disclosure.

The whole or part of the example embodiments disclosed above can be described as, but not limited to, the following Supplementary notes.

### Supplementary Note 1

A vehicle control system comprising:
a plurality of vehicles, each of the plurality of vehicles being configured so as to be able to be remotely driven;
an analysis means for receiving information about each of the plurality of vehicles from each of the vehicles through a network, and analyzing state information of each of the vehicles based on the received information about each of the vehicles;
a plurality of remote control means, each of the plurality of remote control means being capable of performing at least one of remote monitoring or remote control for at least one of the plurality of vehicles; and
an assignment determination means for determining a correspondence relationship between the vehicles and the remote control means based on the state information analyzed by the analysis means.

### Supplementary Note 2

The vehicle control system described in Supplementary note 1, wherein
the plurality of vehicles include a passenger vehicle, and each of the plurality of remote control means is associated with a remote observer who remotely controls the vehicle,
the analysis means receives an image of the inside of the vehicle which is the passenger vehicle from the vehicle, and analyzes whether or not a passenger is in the vehicle based on the received image, and
the assignment determination means determines a correspondence relationship between the vehicle which is the passenger vehicle and the remote control means based on a result of the analysis as to whether or not the passenger is in the vehicle and a type of license possessed by the remote observer.

### Supplementary Note 3

The vehicle control system described in Supplementary note 2, wherein when a passenger is in the vehicle which is the passenger vehicle, the assignment determination means assigns this vehicle to a remote control means associated with a remote observer possessing a license for driving the passenger vehicle, whereas when no passenger is in the vehicle which is the passenger vehicle, the assignment determination means assigns this vehicle to a remote control means associated with a remote observer possessing a license for driving the passenger vehicle or a remote observer who does not possess the license.

### Supplementary Note 4

The vehicle control system described in Supplementary note 1, wherein
the plurality of vehicles include a passenger vehicle, and each of the plurality of remote control means is associated with a remote observer who remotely controls the vehicle,
the analysis means receives information indicating whether or not the vehicle which is the passenger vehicle is out of service from the vehicle, and analyzes whether or not the vehicle is out of service based on the received information, and
the assignment determination means determines a correspondence relationship between the vehicle which is the passenger vehicle and the remote control means based on a result of the analysis as to whether or not the vehicle is out of service and a type of license possessed by the remote observer.

### Supplementary Note 5

The vehicle control system described in Supplementary note 4, wherein when the vehicle which is the passenger vehicle is not out of service, the assignment determination means assigns this vehicle to a remote control means associated with a remote observer possessing a license for driving the passenger vehicle, whereas when the vehicle which is the passenger vehicle is out of service, the assignment determination means assigns this vehicle to a remote control means associated with a remote observer possessing a license for driving the passenger vehicle or a remote observer who does not possess the license.

### Supplementary Note 6

The vehicle control system described in Supplementary note 1, wherein
each of the plurality of remote control means is associated with a remote observer who remotely controls the vehicle,
the analysis means analyzes a road-surface condition of a place where the vehicle is traveling based on information about the vehicle, and
the assignment determination means determines a correspondence relationship between the vehicle and the remote control means based on the analyzed road-surface condition and information about suitability of the remote observer for the road-surface condition.

### Supplementary Note 7

The vehicle control system described in Supplementary note 6, wherein
the information about the suitability includes information indicating whether or not the remote observer is suitable for at least one of a dry road surface, a wet road surface, a snow-covered road surface, or an icy road surface, and
the assignment determination means refers to the information about the suitability and assigns, to the vehicle, a remote control means associated with a remote observer who is suitable for driving the vehicle under the analyzed road-surface condition.

### Supplementary Note 8

The vehicle control system described in any one of Supplementary notes 1 to 7, wherein the information about each of the vehicles received by the analysis means includes an image taken by a camera disposed in each of the vehicles.

### Supplementary Note 9

The vehicle control system described in any one of Supplementary notes 1 to 8, wherein
each of the plurality of vehicles is further configured to be able to perform autonomous driving, and
the remote control means controls the autonomous driving of the vehicle by specifying a control policy in the autonomous driving based on information about the vehicle and transmitting the specified control policy to the vehicle.

### Supplementary Note 10

A vehicle control apparatus comprising:
an analysis means for receiving information about each of a plurality of vehicles from each of the vehicles through a network, and analyzing state information of each of the vehicles based on the received information about each of the vehicles, each of the vehicles being configured so as to be able to be remotely driven;
a plurality of remote control means, each of the plurality of remote control means being capable of performing at least one of remote monitoring or remote control for at least one of the plurality of vehicles; and
an assignment determination means for determining a correspondence relationship between the vehicles and the remote control means based on the state information analyzed by the analysis means.

### Supplementary Note 11

The vehicle control apparatus described in Supplementary note 10, wherein
the plurality of vehicles include a passenger vehicle, and each of the plurality of remote control means is associated with a remote observer who remotely controls the vehicle,
the analysis means receives an image of the inside of the vehicle which is the passenger vehicle from the vehicle, and analyzes whether or not a passenger is in the vehicle based on the received image, and
the assignment determination means determines a correspondence relationship between the vehicle which is the passenger vehicle and the remote control means based on a result of the analysis as to whether or not the passenger is in the vehicle and a type of license possessed by the remote observer.

### Supplementary Note 12

The vehicle control apparatus described in Supplementary note 10, wherein
the plurality of vehicles include a passenger vehicle, and each of the plurality of remote control means is associated with a remote observer who remotely controls the vehicle,
the analysis means receives information indicating whether or not the vehicle which is the passenger vehicle is out of service from the vehicle, and analyzes whether or not the vehicle is out of service based on the received information, and
the assignment determination means determines a correspondence relationship between the vehicle which is the passenger vehicle and the remote control means based on a result of the analysis as to whether or not the vehicle is out of service and a type of license possessed by the remote observer.

### Supplementary Note 13

The vehicle control apparatus described in Supplementary note 10, wherein
each of the plurality of remote control means is associated with a remote observer who remotely controls the vehicle,
the analysis means receives information about weather in a place where the vehicle is traveling, and analyzes a road-surface condition of the place where the vehicle is traveling, and
the assignment determination means determines a correspondence relationship between the vehicle and the remote control means based on the analyzed road-surface condition and information about suitability of the remote observer for the road-surface condition.

### Supplementary Note 14

A vehicle control method comprising:
receiving information about each of a plurality of vehicles from each of the vehicles through a network, and analyzing state information of each of the vehicles based on the received information about each of the vehicles, each of the vehicles being configured so as to be able to be remotely driven; and
determining a correspondence relationship between a plurality of remote control apparatuses and the vehicles based on the analyzed state information, each of the plurality of remote control apparatuses being capable of performing at least one of remote monitoring or remote control for at least one of the plurality of vehicles.

### Supplementary Note 15

A non-transitory computer readable medium storing a program for causing a computer to perform processes including:
receiving information about each of a plurality of vehicles from each of the vehicles through a network, and analyzing state information of each of the vehicles based on the received information about each of the vehicles, each of the vehicles being configured so as to be able to be remotely driven; and
determining a correspondence relationship between a plurality of remote control apparatuses and the vehicles based on the analyzed state information, each of the plurality of remote control apparatuses being capable of performing at least one of remote monitoring or remote control for at least one of the plurality of vehicles.

### Reference Signs List

| | |
|---|---|
| 10 | VEHICLE CONTROL SYSTEM |
| 20 | VEHICLE CONTROL APPARATUS |
| 21 | ANALYSIS MEANS |
| 22 | ASSIGNMENT DETERMINATION MEANS |
| 23 | REMOTE CONTROL MEANS |
| 30 | VEHICLE |
| 100 | VEHICLE CONTROL SYSTEM |
| 101 | VEHICLE CONTROL APPARATUS |
| 102 | NETWORK |
| 111 | ANALYSIS UNIT |
| 112 | ASSIGNMENT DETERMINATION MEANS |
| 113 | REMOTE CONTROL UNIT |
| 200 | VEHICLE |
| 201 | SENSOR |

What is claimed is:

1. A vehicle control system comprising:
a plurality of vehicles, each of the plurality of vehicles being configured so as to be able to be remotely driven; and
a vehicle control apparatus comprising at least one memory storing instructions and at least one processor configured to execute the instructions to:
receive information about each of the plurality of vehicles from each of the vehicles through a network;
analyze state information of each of the vehicles based on the received information about each of the vehicles;
determine assignment of the vehicles to be performed at least one of remote monitoring or remote control based on the state information; and
perform at least one of remote monitoring or remote control for at least one of the plurality of vehicles.

2. The vehicle control system according to claim 1, wherein
the plurality of vehicles include a passenger vehicle,
the at least one processor is configured to execute the instructions to receive an image of the inside of the vehicle which is the passenger vehicle from the vehicle, and analyze whether or not a passenger is in the vehicle based on the received image, and
determine a remote observer who remotely controls the vehicle to be assigned to the vehicle which is the passenger vehicle based on a result of the analysis as to whether or not the passenger is in the vehicle and a type of license possessed by the remote observer.

3. The vehicle control system according to claim 2, wherein when a passenger is in the vehicle which is the passenger vehicle, the at least one processor is configured to execute the instructions to assign this vehicle to a remote observer possessing a license for driving the passenger vehicle, whereas when no passenger is in the vehicle which is the passenger vehicle, the at least one processor is configured to execute the instructions to assign this vehicle to a remote observer possessing a license for driving the passenger vehicle or a remote observer who does not possess the license.

4. The vehicle control system according to claim 1, wherein
the plurality of vehicles include a passenger vehicle,
the at least one processor is configured to execute the instructions to receive information indicating whether or not the vehicle which is the passenger vehicle is out of service from the vehicle, and analyze whether or not the vehicle is out of service based on the received information, and
the at least one processor is configured to execute the instructions to determine a remote observer who remotely controls the vehicle to be assigned to the vehicle which is the passenger vehicle based on a result of the analysis as to whether or not the vehicle is out of service and a type of license possessed by the remote observer.

5. The vehicle control system according to claim 4, wherein when the vehicle which is the passenger vehicle is not out of service, the at least one processor is configured to execute the instructions to assign this vehicle to a remote observer possessing a license for driving the passenger vehicle, whereas when the vehicle which is the passenger vehicle is out of service, the at least one processor is configured to execute the instructions to assign this vehicle to a remote observer possessing a license for driving the passenger vehicle or a remote observer who does not possess the license.

6. The vehicle control system according to claim 1, wherein
the at least one processor is configured to execute the instructions to analyze a road-surface condition of a place where the vehicle is traveling based on information about the vehicle, and
the at least one processor is configured to execute the instructions to determine a remote observer who remotely controls the vehicle to be assigned to the vehicle based on the analyzed road-surface condition and information about suitability of the remote observer for the road-surface condition.

7. The vehicle control system according to claim 6, wherein
the information about the suitability includes information indicating whether or not the remote observer is suitable for at least one of a dry road surface, a wet road surface, a snow-covered road surface, or an icy road surface, and
the at least one processor is configured to execute the instructions to refer to the information about the suitability and assign, to the vehicle, a remote observer who is suitable for driving the vehicle under the analyzed road-surface condition.

8. The vehicle control system according to claim 1 , wherein the information about each of the vehicles received by the at least one processor includes an image taken by a camera disposed in each of the vehicles.

9. The vehicle control system according to claim 1 , wherein
each of the plurality of vehicles is further configured to be able to perform autonomous driving, and
the at least one processor is configured to execute the instructions to control the autonomous driving of the vehicle by specifying a control policy in the autonomous driving based on information about the vehicle and transmitting the specified control policy to the vehicle.

10. A vehicle control apparatus comprising:
at least one memory storing instructions, and
at least one processor configured to execute the instructions to:
receive information about each of a plurality of vehicles from each of the vehicles through a network;
analyze state information of each of the vehicles based on the received information about each of the vehicles, each of the vehicles being configured so as to be able to be remotely driven;
determine assignment of the vehicles to be performed at least one of remote monitoring or remote control based on the state information; and
perform at least one of remote monitoring or remote control for at least one of the plurality of vehicles .

11. The vehicle control apparatus according to claim 10, wherein
the plurality of vehicles include a passenger vehicle ,
the at least one processor is configured to execute the instructions to receive an image of the inside of the vehicle which is the passenger vehicle from the vehicle, and analyze whether or not a passenger is in the vehicle based on the received image, and
the at least one processor is configured to execute the instructions to determine a remote observer who remotely controls the vehicle to be assigned to the vehicle which is the passenger vehicle based on a result of the analysis as to whether or not the passenger is in the vehicle and a type of license possessed by the remote observer.

12. The vehicle control apparatus according to claim 10, wherein
the plurality of vehicles include a passenger vehicle,
the at least one processor is configured to execute the instructions to receive information indicating whether or not the vehicle which is the passenger vehicle is out of service from the vehicle, and analyze whether or not the vehicle is out of service based on the received information, and
the at least one processor is configured to execute the instructions to determine a remote observer who remotely controls the vehicle to be assigned to the vehicle which is the passenger vehicle based on a result of the analysis as to whether or not the vehicle is out of service and a type of license possessed by the remote observer.

13. The vehicle control apparatus according to claim 10, wherein
the at least one processor is configured to execute the instructions to receive information about weather in a place where the vehicle is traveling, and analyze a road-surface condition of the place where the vehicle is traveling, and
the at least one processor is configured to execute the instructions to determine a remote observer who remotely controls the vehicle to be assigned to the vehicle based on the analyzed road-surface condition and information about suitability of the remote observer for the road-surface condition.

14. A vehicle control method comprising:
receiving information about each of a plurality of vehicles from each of the vehicles through a network, and analyzing state information of each of the vehicles based on the received information about each of the vehicles, each of the vehicles being configured so as to be able to be remotely driven;
determining assignment of the vehicles to be performed at least one of remote monitoring or remote control based on the analyzed state information; and
performing at least one of remote monitoring or remote control for at least one of the plurality of vehicles.

15. (canceled)
